(19) United States
(12) Patent Application Publication
(10) Pub. No.: US 2014/0272839 A1
(43) Pub. Date: Sep. 18, 2014

(54) BEHAVIOR MODIFICATION METHODS AND SYSTEMS

(71) Applicant: Zachary CUTLER, Cape Elizabeth, ME (US)

(72) Inventor: Zachary CUTLER, Cape Elizabeth, ME (US)

(21) Appl. No.: 13/798,845

(22) Filed: Mar. 13, 2013

(51) Int. Cl. G09B 5/02

(52) U.S. Cl. CPC G09B 5/02
USPC 434/236

(57) ABSTRACT

Methods and systems for altering behavior by providing a first stimulus to a subject. The first stimulus is an interactive activity requiring that the subject perform one or more actions to interact with one or more icons on one or more computing devices. The first stimulus is selected to correspond to a current physiological or neurocognitive state for the subject. The performance of the subject is monitored in response to the first stimulus. A second stimulus is provided to the subject in response to determining that the subject's performance in response to the first stimulus satisfies a predetermined condition. The second stimulus is an interactive activity requiring that the subject perform one or more actions to interact with one or more icons on the one or more computing devices. The second stimulus is selected to correspond to a new physiological or neurocognitive state for the subject.

### BACKGROUND

‘Stress’ is currently an immensely popular topic of both research and discussion in the life sciences. Overwhelming amounts of data are beginning to elucidate the deleterious physiological, cognitive, and behavioral effects of cumulative, stress-related allostatic processes. Chronic stress has been linked to neurodegenerative disease, arthritis, cardiac dysfunction, executive function deficit, depression—the list goes on. Higher levels of chronic social and work stress and, specifically, of HPA axis hormones (e.g., corticotrophin releasing factor (CRF)) are also positively correlated with an increased risk for relapse of undesirable chronic behaviors (e.g., addictive/substance-abusing behavior, maladaptive coping strategies). However, in addition to factors that fit into a colloquial understanding of stress—factors like excessive workload or sleep deprivation, for example—anecdotal evidence and research data are beginning to point to the fact that living in fast-paced, stimulus-saturated environments does not just result in distractible behavior, it may also contribute to stress-related processes traditionally associated with social and emotional stress. That is, there is some degree of allostatic cost that results purely from the information processing and sensory demands of developed, modern environments.

### SUMMARY

From a cognitive standpoint, certain types of environments (e.g., cities, rather than country settings) encourage frequent shifting of attentional set; there is a functional demand for it. Often consuming media via the world wide web, we spend more time synthesizing information than we used to and we spend less time searching for and absorbing in-depth information on a single given subject. We live in active and often frenetic environments and we are exposed to a staggering degree of stimuli and information relative to what human beings have been exposed to during earlier times in history. We are seeing an increase in the propensity to shift conscious awareness in response to internal or external stimuli, and that increase has to come at the expense of the capacity for sustained attention and inhibition of extraneous or disruptive stimuli.

Cognitive capacities and physiological state operate in concert with one another—cognitive activity is supported by neurophysiological mechanisms. Cognitive demand—especially demand that requires executive resources (e.g., working memory)—results in observable changes in physiological state that indicate increased metabolic activity (e.g., faster EEG activity, increases in muscle tension, increased heart rate, reduced heart rate variability). Similar effects are observable in situations of sensory overload. Thus, we can infer that environmentally mediated cognitive and sensory demands can contribute to elevated levels of both phasic (i.e., acute) and tonic (i.e., chronic) arousal.

The relationship between arousal and cognition is bidirectional. Just as environmentally mediated cognitive and sensory demand (i.e., task demand and task environment) will influence physiological state, independent changes in physiological state will also influence cognitive biases—for a given physiological state, there are certain cognitive and behavioral patterns that are potentiated and certain cognitive and behavioral patterns that are depotentiated. This is the rationale used to prescribe psycho-stimulant medication to individuals who have been diagnosed with Attention Deficit Hyperactivity Disorder (ADHD). ADHD is thought to result, in part, from the inability of a subject to generate the neurophysiological arousal necessary to support metabolically costly cognitive task demands (i.e., executive functions). Because the system does not generate the arousal natively, caregivers prescribe a compound that is capable of creating that arousal. This provides the substrates necessary to support executive brain areas in meeting the cognitive demands of more complex tasks that are, cognitively speaking, metabolically costly.

Many observations have been made in the research literature regarding the relationship between arousal level, task characteristics, and performance. Of notable relevance, performance of simpler or well-learned tasks generally benefits from higher levels of arousal while performance of more complex or unmastered tasks generally benefits from lower levels of arousal.

It has been suggested that a possible mechanism for explaining the observed relationship between arousal, task complexity, and performance is that as arousal increases, attentional focus narrows. Thus, depending upon both the complexity of current task demands and upon the relative skill of the performer (which affects the subjective complexity of the task), there is a theoretically “optimal” level of arousal. At an optimum arousal level, attentional focus has narrowed to the point that task-irrelevant cues have been inhibited in awareness while task-relevant cues remain, thus maximizing performance. If arousal is too low and attention is too broad, irrelevant cues are present in awareness and cause a decrement in performance; on the other hand, if arousal is too high and attentional focus narrows beyond an optimal point, then some task-relevant cues are also inhibited and performance suffers, accordingly.

Both relevant and irrelevant cues may occur in the internal environment—that is, in the cognitive or interoceptive environment. For example, with regard to balancing self-regulatory demands with work demands, if someone is extremely engaged in a work activity and experiencing a great deal of “stress” (e.g., time pressure, a micromanaging supervisor), it is possible they will be experiencing a maladaptively elevated level of arousal which may interfere with their ability to balance the task demands of work with personal or self-regulatory task demands. Their focus may narrow to the point that they neglect cues from interoceptive sources (e.g., neglecting hunger pangs and “forgetting” to eat lunch) or cognitive sources (e.g., “forgetting” to pick one's child up from soccer). Stress processes can cause a decrement in both chronic and acute attentional flexibility—the capacity of a subject to adaptively shift the locus of their attentional focus in accordance with task demands as well as their capacity to fluidly modulate the breadth of their focus (i.e., their ability to transition from a narrow focus—focusing on a specific work demand, for example—to a broad focus—broadening content in awareness to include interoceptive and internal cognitive cues, for example). In extreme cases, this attentional narrowing may lead to a shortening of the time horizon or neglect of the more distant consequences of an immediate action.

Higher levels of phasic arousal can also produce a predisposition toward stimulus-driven behavior, often resulting in frequent and relatively involuntary shifting of attentional set; not only does a subject's attentional focus narrow, but it also begins to shift more frequently and may become disproportionately responsive to arousal-producing/arousal-maintaining cues. In an evolutionary framework, the propensity of attentional focus to significantly narrow as well as shift more frequently in response to substantial increases in arousal might be considered analogous to a state of searching for and appraising potential threats or opportunities. Cues that produce arousal are likely to function as attention-sinks and to capture conscious awareness. Such cues include cues and contexts that are associated with habitual/addictive behaviors as well as those associated with exciting/stress-producing behaviors. Over the course of human evolution, these processes served to direct awareness toward threats and opportunities so that they might be avoided and/or taken advantage of, and they did so based upon a cue's capacity to create and/or maintain arousal in a subject. For example, if a subject's lower, subcortical brain structures interpreted a cue that could have signified the presence of a potential predator—a rustling in the brush, for example—and then induced a physiological response (e.g., increased heart rate, constricted blood vessels) the subject's higher brain center (i.e., the seat of conscious behavioral planning) would have been directed toward the perceived source of the change in physiological state in order to investigate the cause of that change. This dynamic was adaptive with regard to threats and opportunities that occurred in an uncertain and often physically dangerous environment (i.e., the environments of our hunter-gatherer ancestors), but is largely maladaptive with regard to the [social] threats and [social] opportunities of developed, modern environments; social contexts are by definition complex and dynamic. Threats and opportunities occurring in a social context typically require attention to a large breadth of cues if successful “performance” is to occur. Extreme attentional narrowing is also particularly maladaptive in many self-regulatory contexts (e.g., a situation in which an individual is exposed to a cue that has become associated with addictive behaviors). If an individual is, for example, “excited”, “anxious”, or “energized”, the probability of that individual shifting their attention at any given moment may increase and the identification of and fixation upon stress-related or addiction-related cues in the internal (e.g., interoceptive, cognitive) or external environment becomes more likely. When conscious awareness identifies an [internal or external] environmental cue that enhances arousal, it is likely to fixate upon it; we see a hyperbolized example of this dynamic in literature investigating implicit cognitive biases in addiction processes, and we see analogues of this dynamic in cognitive processes associated with stress.

Fixation upon an addiction-related or stress-related cue is particularly problematic given the relationship between arousal levels and the tendency to engage in habitual or practiced behavior. From a behavioral perspective, increasing levels of arousal potentiate what is known as the dominant response to a given cue or cue environment. Excitement or stress facilitates the expression of automatized behaviors—that is, excitement or stress are likely to increase the proportion of behavior that is stimulus-driven. This relationship explains the interaction between central nervous system excitation and task difficulty in affecting performance levels. As referenced earlier, higher levels of phasic arousal improve the performance of well-practiced behaviors, but interfere with newer, less practiced behaviors. For an applied example, consider that it is particularly important to emphasize calm mental/physiological states when teaching new, complex movements (i.e., ‘motor programs’) to aspiring athletes. In some instances it is even useful to have athletes engage in relaxation techniques prior to performing complex, explosive movements (e.g., swinging a baseball bat or jumping to dunk a basketball) that are new to them. This can at first seem counter-intuitive given that explosive movements are, by definition, meant to be executed in a fast and forceful manner; while it is true that, in a performance context, these movements generally benefit from high arousal, this is only the case when cognitive control of a movement or skill has been well-learned and no longer requires controlled processing (i.e., conscious attention to the relatively wide breadth of cues associated with correct execution of a new movement or skill). In such cases, cognitive control of the movement is achieved via automatic processing (i.e., execution is monitored by the brain but requires little to no conscious attention—the layman's term “muscle memory” is often invoked to describe this type of processing in the context of motor behavior). The transition of cognitive control from controlled to automatic processing for a complex movement can require several hundred to thousands of repetitions.

If we understand addictive behavior or habitual behaviors associated with stress (e.g., a “nervous habit” like cracking one's knuckles) to be extreme examples of “practiced” behaviors, then it is possible to predict that extreme levels of arousal will increase the likelihood that these addictive, habitual, or stress-related behaviors will be expressed or, alternatively, we might assume that higher levels of arousal will at the very least depotentiate behaviors that are not well-learned. In a given context, higher relative levels of excitement and stress will cause new behaviors to go out the window.

The technology described herein relates to systems and methods for altering behavior of subjects in a manner that is active, stimulating, and engaging, but which does not oppose cognitive processing biases the subject is experiencing.

One implementation is a method for altering behavior of a subject. The method includes providing, via one or more computing devices, a first stimulus to a subject. The first stimulus is an interactive activity requiring that the subject perform one or more actions to interact with one or more icons on the one or more computing devices. The first stimulus is selected by the one or more computing devices to correspond to a current physiological or neurocognitive state for the subject. The method also includes monitoring, via the one or more computing devices, the performance of the subject in response to the first stimulus. The method also includes providing, via the one or more computing devices, a second stimulus to the subject in response to the one or more computing devices determining that the subject's performance in response to the first stimulus satisfies a predetermined condition. The second stimulus is an interactive activity requiring that the subject perform one or more actions to interact with one or more icons on the one or more computing devices, and wherein the second stimulus is selected by the one or more computing devices to correspond to a new physiological or neurocognitive state for the subject.

In some embodiments, monitoring the performance of the subject in response to the first stimulus includes quantitatively measuring a metric that corresponds to the performance of the subject in performing the one or more actions, to a physiological state of the subject in response to the subject performing the one or more actions, or a combination of both.

In some embodiments, the method includes monitoring, via the one or more computing devices, the performance of the subject in response to the second stimulus and providing, via the one or more computing devices, a third stimulus to the subject in response to the one or more computing devices determining that the subject's performance for the second stimulus satisfies a predetermined condition. The third stimulus can be an interactive activity requiring that the subject perform one or more actions to interact with one or more icons on the one or more computing devices, and wherein the third stimulus is selected by the one or more computing devices to correspond to a new physiological or neurocognitive state for the subject.

In some embodiments, the second stimulus provided to the subject is an interactive activity requiring that the subject perform one or more actions to interact with one or more icons on a touch sensitive display device, and wherein the interactive activity associated with the second stimulus has an increased or decreased frequency, magnitude, or combination of both, relative to the interactive activity associated with the first stimulus. In some embodiments, the method includes providing the subject with a request, via the one or more computing devices, to input a response that is an indication of the subject's current physiological or neurocognitive state.

In some embodiments, the one or more computing devices select the first stimulus in response to measurement of a physiological state of the subject. In some embodiments, the new physiological or neurocognitive state for the subject is a desired physiological or neurocognitive state for the subject to achieve. In some embodiments, the first stimulus is selected by the one or more computing devices to match the subject's level of excitation prior to providing the first stimulus to the subject. In some embodiments, the second stimulus is selected by the one or more computing devices to guide the subject to a state corresponding to a lower arousal level or a higher arousal level.

In some embodiments, the second stimulus selected to guide the subject to a state corresponding to a lower arousal level includes decreasing, relative to the first stimulus, a number of attention shifting actions expected of the subject, decreasing, relative to the first stimulus, a number of interactions expected of the subject with the one or more icons within a period of time, changing, relative to the first stimulus, color themes in visual stimulation components of the interactive activity towards colors corresponding to relaxing colors, or decreasing, relative to the first stimulus, perceptual load of the subject's sensory environment.

In some embodiments, the second stimulus selected to guide the subject to a state corresponding to a higher arousal level includes increasing, relative to the first stimulus, a number of attention shifting actions expected of the subject, increasing, relative to the first stimulus, a number of interactions expected of the subject with the one or more icons within a period of time, changing, relative to the first stimulus, color themes in visual stimulation components of the interactive activity towards colors corresponding to higher excitement colors, or increasing, relative to the first stimulus, perceptual load of the subject's sensory environment.

Another implementation is a system for altering behavior of a subject. The system includes one or more processors and a memory. The memory includes code representing instructions that when executed cause the one or more processors to provide a first stimulus to a subject. The first stimulus is an interactive activity requiring that the subject perform one or more actions to interact with one or more icons on one or more computing devices. The first stimulus is selected by the one or more computing devices to correspond to a current physiological or neurocognitive state for the subject. The memory includes code representing instructions that when executed cause the one or more processors to monitor the performance of the subject in response to the first stimulus. The memory includes code representing instructions that when executed cause the one or more processors to provide a second stimulus to the subject in response to the one or more computing devices determining that the subject's performance in response to the first stimulus satisfies a predetermined condition, wherein the second stimulus is an interactive activity requiring that the subject perform one or more actions to interact with one or more icons on the one or more computing devices, and wherein the second stimulus is selected by the one or more computing devices to correspond to a new physiological or neurocognitive state for the subject.

In some embodiments, the memory includes code representing instructions that when executed cause the one or more processors to quantitatively measure a metric that corresponds to the performance of the subject in performing the one or more actions, to a physiological state of the subject in response to the subject performing the one or more actions, or a combination of both. In some embodiments, the second stimulus provided to the subject is an interactive activity requiring that the subject perform one or more actions to interact with one or more icons on a touch sensitive display device, and wherein the interactive activity associated with the second stimulus has an increased or decreased frequency, magnitude, or combination of both, relative to the interactive activity associated with the first stimulus.

In some embodiments, the new physiological or neurocognitive state for the subject is a desired physiological or neurocognitive state for the subject to achieve. In some embodiments, the first stimulus is selected by the one or more processors to match the subject's level of excitation. In some embodiments, the second stimulus is selected by the one or more processors to guide the subject to a state corresponding to a lower arousal level or a higher arousal level.

In some embodiments, the predetermined condition is satisfied when a period of time has elapsed, when a measured metric that corresponds to the performance of the subject in performing the one or more actions is achieved, when a measured physiological state of the subject is achieved in response to the subject performing the one or more actions, or a combination of these factors.

Another implementation is a computer program product, tangibly embodied in an information carrier. The computer program product includes instructions being operable to cause a data processing apparatus to provide a first stimulus to a subject. The first stimulus is an interactive activity requiring that the subject perform one or more actions to interact with one or more icons on one or more computing devices. The first stimulus is selected by the one or more computing devices to correspond to a current physiological or neurocognitive state for the subject. The computer program product includes instructions being operable to cause a data processing apparatus to monitor the performance of the subject in response to the first stimulus. The computer program product includes instructions being operable to cause a data processing apparatus to provide a second stimulus to the subject in response to the one or more computing devices determining that the subject's performance in response to the first stimulus satisfies a predetermined condition. The second stimulus is an interactive activity requiring that the subject perform one or more actions to interact with one or more icons on the one or more computing devices. The second stimulus is selected by the one or more computing devices to correspond to a new physiological or neurocognitive state for the subject.

The behavior modification methods and systems described herein (hereinafter “technology”) can provide one or more of the following advantages. One advantage of the technology is that it can capture a desirable amount of the attention of the subject by matching the subject's physiological/neurocognitive state to the demands of the activity presented to the subject. Another advantage is that the technology improves the likelihood that a subject will engage with the method for altering his/her behavior because the activity requested of the subject will be active, stimulating, engaging, and will not oppose cognitive processing biases the subject is experiencing. Another advantage of the technology is that it establishes desirable (e.g., maximum) levels of engagement of the subject because activities presented to the subject occupy a subject's awareness to a degree sufficient to limit or eliminate cognitive resources that might otherwise be used to process environmental cues, thoughts, or sensations that could otherwise lead to the initiation of stress-related, habitual, or addictive behavior. Another advantage of the technology is that it accomplishes the benefits described herein in an automated or controlled manner because it eliminates the need for intervention from another party (e.g., clinician, therapist, doctor).

### BRIEF DESCRIPTION OF THE DRAWINGS

The foregoing features of various embodiments of the invention will be more readily understood by reference to the following detailed descriptions in the accompanying drawings.

FIG. 1 is a schematic illustration of a subject using a computing device in communication with a system for altering behavior of the subject, according to an illustrative embodiment.

FIG. 2 is a block diagram of a computing device used in altering behavior of a subject, according to an illustrative embodiment.

FIG. 3 is a flowchart of a method for altering behavior of a subject, according to an illustrative embodiment.

FIG. 4A is a schematic illustration of a graphical user interface used in a method for altering behavior of a subject, according to an illustrative embodiment.

FIG. 4B is a schematic illustration of the graphical user interface of FIG. 4A after a subject has interacted with icons on the display of a computing device.

FIG. 4C is a schematic illustration of the graphical user interface of FIG. 4B after a subject has interacted with icons on the display of a computing device.

FIG. 4D is a schematic illustration of the graphical user interface of FIG. 4C after a subject has interacted with icons on the display of a computing device.

FIG. 4E is a schematic illustration of the graphical user interface of FIG. 4D after a subject has interacted with icons on the display of a computing device.

FIG. 4F is a schematic illustration of the graphical user interface of FIG. 4E after a subject has interacted with icons on the display of a computing device.

FIG. 4G is a schematic illustration of the graphical user interface of FIG. 4F after a subject has interacted with icons on the display of a computing device.

### DETAILED DESCRIPTION OF ILLUSTRATIVE EMBODIMENTS

FIG. 1 is a Schematic Illustration Of a Subject 104 using a Computing Device 108 in communication with a system 100 for altering behavior of the subject 104, according to an illustrative embodiment. The system 100 includes an optional measurement system 112 for measuring at least one parameter of at least one physiological or neurocognitive state of the subject 104. In one embodiment, the measurement apparatus 112 is an electrocardiography (ECG) apparatus that measures the electrical activity of the heart over a period of time using a plurality of electrodes attached to the chest of the subject 104. The ECG apparatus detects and amplifies tiny electrical changes on the skin that are caused during each heartbeat. Other types and quantities of measurement apparatus 112 (e.g., electroencephalography apparatus, oximeter) can be used in alternative embodiments to measure physiological and neurocognitive states of the subject 104.

The computing device 108 can be any of a variety of available computing devices that are configured to enable the subject to use the device 108 (e.g., input information, view information on the device). Exemplary computing devices include a personal computer 108a, a tablet computing device 108b, or a touch sensitive computing device 108c. Computer 108a includes a display 116a (e.g., CRT display, LCD display, LED display) and a computer mouse 120a as an input device for the subject 104 to interact with the computer 108a. Tablet computing device 108b includes a display 116b (e.g., a capacitive or touch sensitive LCD display) and a stylus 120b as an input device for the subject 104 to interact with the tablet computing device 108b. Touch sensitive computing device 108c includes a display 116c (e.g., a capacitive or touch sensitive LCD display) and the subject 104 uses its finger to interact with the touch sensitive computing device 108c.

FIG. 2 is a block diagram of a computing device 200 used in altering behavior of a subject, according to an illustrative embodiment. The computing device 200 includes a communication module 216, one or more input devices 220, one or more output devices 228, one or more display devices 224, one or more processors 232, and memory 236. The modules and devices described herein can, for example, utilize the processor 232 to execute computer executable instructions and/or the modules and devices described herein can, for example, include their own processor to execute computer executable instructions. It should be understood the computing device 200 can include, for example, other modules, devices, and/or processors known in the art and/or varieties of the described modules, devices, and/or processors.

The communication module 216 includes circuitry and code corresponding to computer instructions that enable the computing device to send/receive signals to/from a measurement system 208 (e.g., the measurement system 112 of FIG. 1). For example, the communication module 216 provides commands from the processor 232 to the measurement system 208 to control how the measurement system 208 measures metrics that correspond to physiological or neurocognitive states of the subject. The measured metrics can be, for example, stored by the memory 236 or otherwise processed by the processor 232 as described herein.

The input devices 220 receive information from a subject (not shown) and/or another computing system (not shown). The input devices 220 can include, for example, a keyboard, a scanner, a microphone, a stylus, a touch sensitive pad or display. The output devices 228 output information associated with the computing device 200 (e.g., information to a printer, information to an audio speaker)

The display devices 224 display information associated with the computing device 200. The information can include, for example, computing device status information, configuration information, information regarding the activities/tasks/stimulus provided to the subject (e.g., including graphical representations/icons corresponding to the information). The processors 232 execute the operating system and/or any other computer executable instructions for the computing device 200 (e.g., executes applications). The memory 236 stores a variety of information/data, including profiles used by the computing device 200 to specify how the system interacts with the subject or analyzes the performance of the subject. The memory 236 can include, for example, long-term storage, such as a hard drive, a tape storage device, or flash memory; short-term storage, such as a random access memory, or a graphics memory; and/or any other type of computer readable storage.

FIG. 3 is a flowchart 300 of a method for altering behavior of a subject using, for example, the system 100 of FIG. 1. The method includes determining the subject's current physiological or neurocognitive state (step 308). By matching the subject's physiological/neurocognitive state to the demands of an activity to be presented to the subject, the method captures as much of the subject's attention as possible and makes the experience as non-aversive/pleasant as possible. The subject's current physiological or neurocognitive state can be determined by requesting the subject to input his/her current state (step 332). The computing device used by the subject (e.g., computing device 108a of FIG. 1) provides the subject with a request, via the computing device, to input a response that is an indication of the subject's current physiological or neurocognitive state.

In some embodiments, the system asks the subject to respond to a question that is meant to identify the subject's physiological or neurocognitive state (e.g., state of excitation). For example, in one implementation, the computing device poses the following question to the subject: “How do you feel and how long do you have to play?” The subject may respond by inputting a response or by selecting one of a variety of predefined responses for the “How do you feel” portion of the question: Stressed, Anxious, Overwhelmed, Energized, Motivated, Neutral, Alert, Tired, Fatigued, Undermotivated, Relaxed, Calm. In addition, the subject might also input a response or select one of a variety of predefined responses for the “how long do you have to play” portion of the question: 3 minutes, 10 minutes, 20 minutes, 30 minutes, less than 5 minutes, greater than 25 minutes.

By way of example, if a subject uses a word with a particular valence, the system (e.g., computing device) determines that the subject would like to be experiencing a different level of arousal than they are currently feeling in order to determine a starting point for the process. The particular valence does not pertain to an evaluation of the subject's interaction with the technology. For example, the word “anxious” has a negative valence and the word “excited” has a positive valence, but both correspond to a high level of arousal. In some implementations, the system determines from the subect's use of negatively valenced words that they find their present state aversive. Referencing the previous example, the subject's use of the word “anxious” rather than “excited” would indicate a current aversion to high arousal at the outset of an interaction with the technology. The intended outcome from using the system would be for the subject to choose a positively valenced word to describe how they feel at the conclusion of using the system, reflecting a successful transition from a subjectively aversive arousal state to subjectively pleasant arousal state. So, we could envision them going from {[tired]→usage→[excited]} or, alternatively, {[anxious]→usage→[calm]}. The words chosen by a subject to identify how they feel can be stored in a data store on the computing device (e.g., memory 236 of FIG. 2). The words can be stored in a table along with a corresponding valence associated with the word to be accessed subsequently by the computing device to determine what stimulus to provide to the subject.

In some embodiments, the method includes measuring a physiological state of the subject (step 336) to determine the current physiological state of the subject. The physiological state of the subject can be determined based on measuring one or more physiological parameters of the subject (e.g., measuring the cardiac activity of the subject using the measurement system 112 of FIG. 1). In some embodiments, the system may determine the current state of a subject by a combination of both a) measuring a physiological state of the subject (step 336) and b) requesting the subject to input his/her current state (step 332).

The method then includes determining a first stimulus to be provided to the subject (step 310). The stimulus provided to the subject is selected by the computing device to correspond to the current physiological or neurocognitive state of the subject as determined in step 308. The stimulus is selected to match the current state because the greater the mismatch between the current state and the stimulus presented to the subject, the greater the risk that it will be experienced as undesirable. Earlier, the relationship between task complexity and arousal level was discussed, and this relationship is relevant to this facet of the technology. If there is a significant mismatch between arousal level and task complexity or sensory environment, the activity may be experienced as “boring” (i.e., an instance where arousal was high and task complexity was low) or “overwhelming” (i.e., an instance in which arousal was low and task complexity was high). In instances where the mismatch is great—particularly in instances in which the activity is experienced as “boring”—there may be activation and cognitive processing of stress-related or addiction-related cues, particularly if the activity is subjectively conceptualized by the user as meant to curb stress-related or addiction-related behavior.

Different types of activities may be provided to the subject. In addition, the activities may also include different sensory cues that are meant to influence the subject's level of arousal. Sensory cues that can be provided to the subject include, for example: aural cues, visual cues, and haptic cues. Aural cues can vary in volume, frequency [the more perceived variance there is in the frequency, the more arousal it should produce (e.g., for a 3-minute period, constant 25 Hz tone frequency vs. 90 seconds at 24 Hz and 90 seconds at 26 Hz)], tone pitch, perceived distance (e.g., this can be manipulated using echo effects). To clarify the preceding language, the term ‘frequency’ is used to refer to the rate or “tempo” of sensory stimulation—for example, a frequency of 24 Hz would indicate temporally circumscribed (i.e., separate) isochronic tones presented at a rate of 24 tones per second; in this document, the term ‘frequency’ is not used to provide an indication of the tone's ‘pitch’—a variable discrete from tempo but which can also be described in terms of ‘Hz’ (i.e., a single, circumscribed tone with a frequency of 500 Hz has a lower ‘pitch’ than a tone with a frequency of 1500 Hz). Visual cues can vary via oscillation of display brightness [at a frequency resonant with aural stimulation], or via visually simulated vibration achieved by oscillating icons within the display. Haptic cues can involve providing tactile feedback at a frequency resonant with the aforementioned frequency-based aural and visual stimulation.

The method then includes providing the first stimulus to the subject (step 312). In some embodiments, the stimulus provided to the subject is an interactive activity requiring that the subject perform one or more actions to interact with one or more icons on the computing device. In some implementations, the nature of the interactivity involves the stimulus encouraging sustained, simultaneous attention to a relatively large number of task-relevant cues (associated with lower arousal levels) or requiring the subject to attend to a relatively smaller number of task-relevant cues and to engage in activities involving interactive planning, attention shifting, and adaptation to a dynamic cue environment (associated with higher arousal levels).

In some implementations the stimulus includes icons of a computerized display, in the form of targets that a subject is supposed to focus on and distractors that a subject should ignore or not focus on. Various properties are altered during the session for the targets and distractors (e.g., average cue speed influences the number of interactions per period of time, cue speed variability). In addition, properties can be varied to affect the distractor discriminatory load (i.e., similarity or dissimilarity of targets to distractors, with more similarity indicating a higher discriminatory load). In addition, properties can be varied to affect target and distractor salience (e.g., level of visual “transparency” for a given cue—how much visual search load there is on the subject). In addition, properties can be varied to affect how many task-relevant cues must be simultaneously tracked at any given time. In addition, properties can be varied to affect how often the subject must re-orient himself/herself. For example, varying how often a subject must re-orient may be accomplished by varying the stability of the cue environment and how many rules the subject must follow for the subject to be successful.

The method then includes monitoring (e.g., via the computing device) the performance of the subject in response to the first stimulus (step 316). In some embodiments, monitoring the performance of the subject includes a) measuring a metric that corresponds to the performance of the subject in performing the one or more actions (step 324), b) measuring a metric that corresponds to a physiological state of the subject (step 340) in response to performing the one or more actions, or a combination of a) and b).

The method then includes determining if the subject's performance satisfies a predetermined condition (step 318). A variety of steps may then be performed, depending on the performance of the subject: repeating (step 328), continuing (step 326) and ending (344). In the instance where the subject's performance does not satisfy a predetermined condition, the system may continue (step 326) providing the first stimulus to the subject until the predetermined condition is satisfied. The system may continue providing the first stimulus to the subject if the subject has not achieved a certain level of performance in performing the actions to interact with the one or more icons on the computing device. The system may also end (step 344) the performance of the method if, for example, the subject has completed all the steps presented to it or has achieved a specific level of performance (e.g., the subject has achieved a desired arousal state).

The technology's capacity to alter arousal level and attentional dynamics provides a significant advantage to its user. Given that different levels of task complexity and/or subjective skill level are either facilitated or impaired by varying levels of arousal, a tool that allows arousal to be manipulated independently will enhance performance. For example, if an office worker is working at a new job and is experiencing an extremely high level of stress/nervousness (i.e., high arousal), their attention may narrow beyond an optimal point relative to the task-demands of work; the use of the technology will allow them to acutely vary (i.e., decrease) their arousal any time they are experiencing a level of stress/arousal that they perceive to be interfering with their ability to perform. Alternatively, if an office worker has been working in the same position for 15 years (i.e., they have mastered occupationally relevant skills) but has trouble generating the motivation to enthusiastically and optimally execute their responsibilities (i.e., they have difficulty generating an optimum level of arousal), the technology may be used to acutely vary (i.e., increase) their arousal. If they are overexcited, an athlete who is attempting to master a new sport skill or is experiencing performance anxiety (e.g., a playoff game in an away stadium) might use the technology to lower arousal; conversely, an athlete who is experiencing amotivation or low energy levels might use the technology to enhance arousal prior to performance.

In some instances, the method includes repeating some of the steps of the method (step 328). For example, the method can include repeating step 310 (determining stimulus), step 312 (providing stimulus), step 316 (monitoring performance), and step 318 (determining if predetermined condition is satisfied). By repeating the steps, the system determines a new stimulus (e.g., second, third . . . as the steps are repeated) to provide to the subject (step 310). For example, repeating step 310 includes determining a second stimulus (or third, fourth, etc.) to be provided to the subject in response to the one or more computing devices determining that the subject's performance, in response to the first stimulus, satisfies a predetermined condition. The second stimulus is an interactive activity requiring that the subject perform one or more actions to interact with one or more icons on the one or more computing devices. The computing device selects the second stimulus so that it corresponds to a new physiological or neurocognitive state for the subject. The new physiological or neurocognitive state for the subject can be a desired physiological or neurocognitive state for the subject to achieve or it can be an intermediary state between a desired physiological or neurocognitive state and the first stimulus. In some embodiments, the second stimulus that is selected guides the subject to a state corresponding to a different arousal level (e.g., lower arousal level or higher arousal level). By creating incremental “steps” in the transition from an initial neurocognitive state (e.g., high arousal) to a desired neurocognitive state (e.g., low arousal), continued engagement is maximized and ultimate success is more likely. The advantage of the incremental approach ultimately hinges upon the fact that the magnitude of the mismatch between the subject's current state and the second stimulus (i.e., a stimulus meant to change the subject's current state) is controlled.

For example, the second stimulus provided to the subject can be an interactive activity requiring that the subject perform one or more actions to interact with one or more icons on a touch sensitive display device (e.g., the display 116c of computing device 108c of FIG. 1). The interactive activity associated with the second stimulus can have, for example, an increased or decreased frequency, magnitude, or combination of both, relative to the interactive activity associated with the first stimulus.

In an implementation where the second stimulus is selected to guide the subject to a state corresponding to a lower arousal level, the system can alter or otherwise change one or more properties associated with the interactive activity required of the subject. In some embodiments, the system decreases, relative to the first stimulus, a number of attention shifting actions expected of the subject. In some embodiments, the system decreases, relative to the first stimulus, a number of interactions expected of the subject with one or more icons within a period of time. In some embodiments, the system changes, relative to the first stimulus, color themes in visual stimulation components of the interactive activity towards colors corresponding to relaxed states. These color themes may be culturally specific. Color themes considered to be relaxing in one culture may not be relaxing in another, and thus the technology would be calibrated to its market, accordingly. In some embodiments, the system decreases, relative to the first stimulus, perceptual load of the subject's sensory environment (e.g., slowing the frequency of sensory stimulation, decreasing the variability of sensory stimulation, decreasing the magnitude of sensory stimulation, increasing the perceived distance of aural sensory stimulation, decreasing visual search load, decreasing visual discriminatory load).

In some embodiments, to guide the user to a lower arousal level, the system increases, relative to the first stimulus, the amount of task-relevant icons the subject must attend to simultaneously. This is a method for broadening attentional focus, thereby creating a task demand that encourages a reduction of arousal. In some embodiments, to guide the user to a lower arousal level, the system increases, relative to the first stimulus, the ratio of task-relevant icons to task-irrelevant icons. This is a method for decreasing the amount of cognitive inhibition required to gait out irrelevant information, thereby creating a task demand that encourages a reduction of arousal. In some embodiments, to guide the user to a lower arousal level, the system decreases, relative to the first stimulus, the visual similarity of task-relevant icons to task-irrelevant icons. This is a method for reducing perceptual/cognitive load, thereby encouraging a reduction of arousal.

In an implementation where the second stimulus is selected to guide the subject to a state corresponding to a higher arousal level, the system can alter or otherwise change one or more properties associated with the interactive activity required of the subject. In some embodiments, the system increases, relative to the first stimulus, a number of attention shifting actions expected of the subject. In some embodiments, the system increases, relative to the first stimulus, a number of interactions expected of the subject with the one or more icons within a period of time. In some embodiments, the system changes, relative to the first stimulus, color themes in visual stimulation components of the interactive activity towards colors corresponding to excited states. As stated previously, these color themes may be culturally specific. In some embodiments, the system increases, relative to the first stimulus, the perceptual load of the subject's sensory environment.

In some embodiments, to guide the user to a higher arousal level, the system decreases, relative to the first stimulus, the amount of task-relevant icons the subject must attend to simultaneously. This is a method for narrowing attentional focus, thereby creating a task demand that encourages an increase of arousal. In some embodiments, to guide the user to a higher arousal level, the system decreases, relative to the first stimulus, the ratio of task-relevant icons to task-irrelevant icons. This is a method for increasing the amount of cognitive inhibition required to suppress irrelevant information, thereby creating a task demand that encourages an increase of arousal. In some embodiments, to guide the user to a higher arousal level, the system increases, relative to the first stimulus, the visual similarity of task-relevant icons to task-irrelevant icons. This is a method for increasing perceptual/cognitive load, thereby encouraging an increase of arousal.

Additionally, there are instances in which the technology may decouple the sensory component of the process from the cognitive component of the process; that is, there are implementations in which sensory stimulation expected to contribute to increasing arousal levels may be paired with task demands best suited to low arousal levels, and vice-versa. This implementation is advantageous because it allows the subject to develop enhanced performance in sensory environments that may otherwise depotentiate task-relevant cognitive functions. For example, this implementation will enable enhanced resistance to the depotentiating effect that overstimulating environments may have on the subject's capacity for sustained concentration or relaxation (i.e., pairing stimulating sensory cues with cognitive demands best suited to low arousal). Alternatively, it will also enable the subject to develop resistance to the depotentiating effect that understimulating environments may have on the capacity for generating the arousal necessary to support executive functions (i.e., pairing non-stimulating or sedating sensory cues with cognitive demands best suited to high arousal).

FIG. 4A is a schematic illustration of a graphical user interface 400 used in a method for altering behavior of a subject using, for example, the system 100 of FIG. 1. In this embodiment, the first stimulus provided to the subject (in accordance with, for example, step 312 of FIG. 3) is an interactive activity that requires the subject to perform actions to interact with one or more icons on a touch sensitive display device (e.g., touch sensitive display device 108c of FIG. 1). The first stimulus requires the subject to redirect target icons 404a and 404b (generally 404, depicted as circular icons) to the target zone 408 (the lower left rectangular area of the 3×3 rectangular field). In this implementation, the processor provides instructions to the subject for performing the activity for the stimulus by outputting an audio description to the subject that tells the subject what to do. In alternative embodiments, text can be displayed to the subject on the display to instruct the subject in how to perform the activity. The subject redirects the icons 404 by touching the icons 404 with a finger placed on the graphical user interface 400 and then moving the finger in the direction in which the subject wants to redirect the target icons 404. In this embodiment, the subject is only able to redirect target icons 404 when they are located in the redirect zone 412 (the central rectangular area of the 3×3 rectangular field). The graphical user interface 400 also includes seven distractor icons 420a, 420b, 420c, 420d, 420e, 420f, and 420g (generally 420).

The arrows 416 of the target icons 404 and distractor icons 420 are used to illustrate the fact that the target icons 404 are able to, for example, move in different and varying directions and speeds. The number and speed of the target icons 420 can be prespecified or automatically specified by the system 100 for the purpose of effectively distracting the subject from the activity of redirecting the target icons 404 in operation.

In some implementations of the method of FIG. 3, properties associated with the first stimulus may be specified such that the first stimulus matches the subject's current (beginning) level of excitation. For example, in this instance the subject's current level of excitation matches a state characterized by very high arousal (as determined in accordance with, for example, steps 308, 332, and 336 of FIG. 3). In this instance, FIG. 4A illustrates a first stimulus provided to a subject for a “very high arousal state” (e.g., providing visual, aural, and/or haptic sensory stimulation in the range of 28-32 Hz). Different properties and property levels can be specified to match the first stimulus state: shifting position of target zone 408, shifting position of redirect zone 412, vanishing of the text used to designate a zone and thus requiring working memory resources to remember that zone's location (a method for increasing cognitive load/arousal), perceptual load level, number of task relevant cues (e.g., number of targets), average icon movement speed, variation in icon movement speed. In one implementation, a high shift rate is used for shifting the position of the target zone, and a high shift rate is used for shifting the location of the redirect zone for the first stimulus for the “very high arousal state.” In this implementation for the “very high arousal state,” the position of the target zone and the redirect zone are shifted every 2-5 seconds. The rate for shifting zones can be varied in alternative embodiments.

The system then monitors the performance of the subject in performing the actions to interact with the icons on the display of the computing device. In this embodiment, the processor in the computing device monitors the subject's performance (e.g., step 316 of FIG. 3). By way of illustration, when the subject is able to redirect the two target icons 404 into the target zone 408, the processor determines that the subject's performance has satisfied the predetermined condition (e.g., step 318 of FIG. 3) required to move on to the next step. In some embodiments, the subject satisfies the predetermined condition when the subject has successfully redirected the two target icons 404 into the target zone 408 multiple times (e.g., 2, 3, or more). FIG. 4B is a schematic illustration of the graphical user interface 400 of FIG. 4A after the subject has interacted with the two target icons 404 icons on the display of the computing device. In this instance, the subject has redirected the two target icons towards the target zone 408 (as illustrated by the direction the arrows 416 of the icons 404 are now pointed).

FIG. 4C is a schematic illustration of the graphical user interface 400 of FIG. 4B after a subject has interacted with the two target icons 404 to redirect the icons 404 towards the target zone 408. In this implementation, the predetermined condition has been satisfied because the subject has successfully redirected the target icons 404 to the target zone 408. As a result, the processor of the computing device (e.g., processor 232 of FIG. 2) determines a new stimulus (e.g., step 310) to provide to the subject. In this embodiment, the method is operating in the manner described above to guide the subject to a state corresponding to a lower arousal level. In this embodiment, the processor then provides a second stimulus to the subject that matches a “moderately high arousal state” (e.g., providing visual, aural, and/or haptic sensory stimulation in the range of 18-22 Hz) in order to guide the subject to an incrementally lower arousal level. In this embodiment, the second stimulus provided to the subject (in accordance with, for example, step 312 of FIG. 3) is similar to the interactive activity described above for the first stimulus. The second stimulus requires the subject to perform actions to interact with the two target icons 404 on the touch sensitive display device. While, in this implementation, the second stimulus is similar to the first stimulus, it is not required. For example, different types of stimuli, actions required of the subject, and variations in other activity parameters can be used in alternative embodiments.

FIG. 4D is a schematic illustration of the graphical user interface 400 depicting providing the second stimulus for the “moderately high arousal state,” in which the subject is tasked with redirecting the two target icons 404 into the target zone 408 (which has moved). In addition, the redirect zone 412 also has been moved. In this implementation, the shift rate used for shifting the position of the target zone, and the shift rate used for shifting the location of the redirect zone have been decreased by the processor for the second stimulus relative to the shift rates that were used for the first stimulus for the “very high arousal state”. In this implementation for the “moderately high arousal state,” the position of the target zone and the redirect zone are shifted every 5-8 seconds.

In this implementation, the predetermined condition required for the subject's performance for the second stimulus has been satisfied when the subject has successfully redirected the target icons 404 to the target zone 408. As a result, the processor of the computing device (e.g., processor 232 of FIG. 2) determines a new (third) stimulus (e.g., step 310) to provide to the subject. In this embodiment, the processor then provides a third stimulus to the subject that matches an “above average arousal state” (e.g., providing visual, aural, and/or haptic sensory stimulation in the range of 13-17 Hz) in order to guide the subject to a lower arousal level. FIG. 4E is a schematic illustration of the graphical user interface 400 depicting the third stimulus for the “above average arousal state”. In this embodiment, the third stimulus provided to the subject (in accordance with, for example, step 312 of FIG. 3) is changed and requires the subject to perform actions to interact with four target icons 404 on the touch sensitive display device. In addition, the number of target items 420 has been increased to four in order to broaden attentional focus, consistent with decreasing arousal. For the third stimulus, the target zone 408 and redirect zone 412 no longer shift position.

In this implementation, the predetermined condition required for the subject's performance for the third stimulus has been satisfied when the subject has successfully redirected all of the target icons 404 to the target zone 408. As a result, the processor of the computing device (e.g., processor 232 of FIG. 2) determines a new (fourth) stimulus (e.g., step 310) to provide to the subject.

In this embodiment, the processor then provides the fourth stimulus to the subject that matches a “moderate arousal state” (e.g., providing visual, aural, and/or haptic sensory stimulation in the range of 8-12 Hz) in order to guide the subject to a lower arousal level. FIG. 4F is a schematic illustration of the graphical user interface 400 depicting providing the fourth stimulus for the “moderate arousal state”. In this embodiment, the fourth stimulus provided to the subject (in accordance with, for example, step 312 of FIG. 3) is changed and requires the subject to interact with nine target icons 404 on the touch sensitive display device. There are no distractor icons, target zone, or redirect zone. The subject is tasked with tapping the touch sensitive display when each of the 9 rectangular areas is occupied by one of the nine icons. In other embodiments, 9 or more icons may be used—in cases in which more than 9 icons are implemented, the predetermined condition involves each of the 9 rectangular areas being occupied by at least one of the 9 or more icons. The icons may vary in, for example, movement, speed, or visual salience

When the predetermined condition has been met, the processor then provides a fifth stimulus to the subject that matches a “low arousal state” (e.g., providing visual, aural, and/or haptic sensory stimulation in the range of 0-7 Hz) in order to guide the subject to a lower arousal level. FIG. 4G is a schematic illustration of the graphical user interface 400 depicting providing the fifth stimulus for the “low arousal state.” The fifth stimulus requires the subject to view the display as a circle 454 of icons 450 moves. The circle 454 increases and decreases (movement depicted as solid icons and dashed icons) in diameter at a very slow rate (e.g., a cycle ranging from 0.1 to 1.0 Hz) In addition, the subject may be given visual or spoken instruction indicating a physical behavior that should be coordinated with the rhythmic movement of the circle (e.g., an instruction to coordinate inhalations and exhalations with the expansion and contraction of the circle 454 of icons 450). The cyclic period (i.e., rate) of the contraction and expansion of the circle 454 of icons 450 may be modulated in response to a measured physiological value or a composite of measured physiological values. In this implementation, the processor determines that the predetermined condition is met after a period of time has passed during which the subject watches the circle (e.g., 3 minutes). When the predetermined condition has been satisfied, the processor ends the session.

In some implementations, the processor, instead, monitors the heart rate variability or other physiological metric of the subject using a measurement system (e.g., measurement system 112 of FIG. 1). When the subject's heart rate variability or other physiological metric reaches a prespecified level, the processor determines that the subject's activity has satisfied the predetermined condition, and the processor ends the session.

The above-described systems and methods can be implemented in digital electronic circuitry, in computer hardware, firmware, and/or software. The implementation can be as a computer program product that is tangibly embodied in an information carrier. The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the disclosure by operating on input data and generating output. Method steps can also be performed by, and an apparatus can be implemented as, special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data. Magnetic, magneto-optical disks, or optical disks are examples of such storage devices.

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The above described techniques can be implemented in a distributed computing system that includes a back-end component. The back-end component can, for example, be a data server, a middleware component, and/or an application server. The components of the system can be interconnected by any form or medium of digital data communication or communication network. Examples of communication networks include a local area network (LAN), a wide area network (WAN), the Internet, wired networks, packet-based networks and/or wireless networks.

Packet-based networks can include, for example, the Internet, a carrier internet protocol (IP) network, such as a local area network (LAN), wide area network (WAN), campus area network (CAN), metropolitan area network (MAN), or home area network (HAN). Networks can also include a private IP network, an IP private branch exchange (IPBX), a wireless network, and/or other packet-based networks. Circuit-based networks can include, for example, the public switched telephone network (PSTN), a private branch exchange (PBX), a wireless network, such as RAN, bluetooth, code-division multiple access (CDMA) network, time division multiple access (TDMA) network, or the global system for mobile communications (GSM) network, and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method for altering behavior of a subject, the method comprising:
providing, via one or more computing devices, a first stimulus to a subject, wherein the first stimulus is an interactive activity requiring that the subject perform one or more actions to interact with one or more icons on the one or more computing devices, and wherein the first stimulus is selected by the one or more computing devices to correspond to a current physiological or neurocognitive state for the subject;
monitoring, via the one or more computing devices, the performance of the subject in response to the first stimulus; and
providing, via the one or more computing devices, a second stimulus to the subject in response to the one or more computing devices determining that the subject's performance in response to the first stimulus satisfies a predetermined condition, wherein the second stimulus is an interactive activity requiring that the subject perform one or more actions to interact with one or more icons on the one or more computing devices, and wherein the second stimulus is selected by the one or more computing devices to correspond to a new physiological or neurocognitive state for the subject.

2. The method of claim 1, wherein monitoring the performance of the subject in response to the first stimulus includes quantitatively measuring a metric that corresponds to the performance of the subject in performing the one or more actions, to a physiological state of the subject in response to the subject performing the one or more actions, or a combination of both.

3. The method of claim 1, comprising:
monitoring, via the one or more computing devices, the performance of the subject in response to the second stimulus; and
providing, via the one or more computing devices, a third stimulus to the subject in response to the one or more computing devices determining that the subject's performance for the second stimulus satisfies a predetermined condition,
wherein the third stimulus is an interactive activity requiring that the subject perform one or more actions to interact with one or more icons on the one or more computing devices, and wherein the third stimulus is selected by the one or more computing devices to correspond to a new physiological or neurocognitive state for the subject.

4. The method of claim 1, wherein the second stimulus provided to the subject is an interactive activity requiring that the subject perform one or more actions to interact with one or more icons on a touch sensitive display device, and wherein the interactive activity associated with the second stimulus has an increased frequency, magnitude, or combination of both, relative to the interactive activity associated with the first stimulus.

5. The method of claim 1, comprising providing the subject with a request, via the one or more computing devices, to input a response that is an indication of the subject's current physiological or neurocognitive state.

6. The method of claim 1, wherein the one or more computing devices select the first stimulus in response to measurement of a physiological state of the subject.

7. The method of claim 1, wherein the new physiological or neurocognitive state for the subject is a desired physiological or neurocognitive state for the subject to achieve.

8. The method of claim 1, wherein the first stimulus is selected by the one or more computing devices to match the subject's level of excitation prior to providing the first stimulus to the subject.

9. The method of claim 1, wherein the second stimulus is selected by the one or more computing devices to guide the subject to a state corresponding to a lower arousal or a higher arousal.

10. The method of claim 9, wherein the second stimulus selected to guide the subject to a state corresponding to a lower arousal includes:
decreasing, relative to the first stimulus, a number of attention shifting actions expected of the subject,
decreasing, relative to the first stimulus, a number of interactions expected of the subject with the one or more icons within a period of time,
changing, relative to the first stimulus, color themes in visual stimulation components of the interactive activity towards colors corresponding to relaxing colors, or
decreasing, relative to the first stimulus, perceptual load of the subject's sensory environment.

11. The method of claim 9, wherein the second stimulus selected to guide the subject to a state corresponding to a higher arousal includes:
increasing, relative to the first stimulus, a number of attention shifting actions expected of the subject,
increasing, relative to the first stimulus, a number of interactions expected of the subject with the one or more icons within a period of time,
changing, relative to the first stimulus, color themes in visual stimulation components of the interactive activity towards colors corresponding to higher excitement colors, or
increasing, relative to the first stimulus, perceptual load of the subject's sensory environment.

12. A system for altering behavior of a subject, the system comprising:
one or more processors; and
a memory, the memory including code representing instructions that when executed cause the one or more processors to:
provide a first stimulus to a subject, wherein the first stimulus is an interactive activity requiring that the subject perform one or more actions to interact with one or more icons on one or more computing devices, and wherein the first stimulus is selected by the one or more computing devices to correspond to a current physiological or neurocognitive state for the subject;
monitor the performance of the subject in response to the first stimulus; and
provide a second stimulus to the subject in response to the one or more computing devices determining that the subject's performance in response to the first stimulus satisfies a predetermined condition, wherein the second stimulus is an interactive activity requiring that the subject perform one or more actions to interact with one or more icons on the one or more computing devices, and wherein the second stimulus is selected by the one or more computing devices to correspond to a new physiological or neurocognitive state for the subject.

13. The system of claim 12, wherein the memory includes code representing instructions that when executed cause the one or more processors to quantitatively measure a metric that corresponds to the performance of the subject in performing the one or more actions, to a physiological state of the subject in response to the subject performing the one or more actions, or a combination of both.

14. The system of claim 12, wherein the second stimulus provided to the subject is an interactive activity requiring that the subject perform one or more actions to interact with one or more icons on a touch sensitive display device, and wherein the interactive activity associated with the second stimulus has an increased frequency, magnitude, or combination of both, relative to the interactive activity associated with the first stimulus.

15. The system of claim 12, wherein the new physiological or neurocognitive state for the subject is a desired physiological or neurocognitive state for the subject to achieve.

16. The system of claim 12, wherein the first stimulus is selected by the one or more processors to match the subject's level of excitation.

17. The system of claim 12, wherein the second stimulus is selected by the one or more processors to guide the subject to a state corresponding to a lower arousal or a higher arousal.

18. The system of claim 12, wherein the predetermined condition is satisfied when a period of time has elapsed, when a measured metric that corresponds to the performance of the subject in performing the one or more actions is achieved, when a measured physiological state of the subject is achieved in response to the subject performing the one or more actions, or a combination of these factors.

19. A computer program product, tangibly embodied in an information carrier, the computer program product including instructions being operable to cause a data processing apparatus to:
provide a first stimulus to a subject, wherein the first stimulus is an interactive activity requiring that the subject perform one or more actions to interact with one or more icons on one or more computing devices, and wherein the first stimulus is selected by the one or more computing devices to correspond to a current physiological or neurocognitive state for the subject;
monitor the performance of the subject in response to the first stimulus; and
provide a second stimulus to the subject in response to the one or more computing devices determining that the subject's performance in response to the first stimulus satisfies a predetermined condition, wherein the second stimulus is an interactive activity requiring that the subject perform one or more actions to interact with one or more icons on the one or more computing devices, and wherein the second stimulus is selected by the one or more computing devices to correspond to a new physiological or neurocognitive state for the subject.
